(19) United States
(12) Patent Application Publication
(10) Pub. No.: US 2005/0132623 A1
(43) Pub. Date: Jun. 23, 2005

(54) Stemware with decorative bases and related methods of fabricating same

(76) Inventors: Steven Farmer, Mooresville, NC (US); Barry Dailey, Davidson, NC (US)

Correspondence Address: Julie H. Richardson;Myers Bigel Sibley & Sajovec, P.A., P.O. Box 37428, Raleigh, NC, 27627, US

(21) Appl. No.: 10/738,553

(22) Filed: Dec. 17, 2003

(51) Int. Cl. G09F 3/00

(52) U.S. Cl. 40/324

(57) ABSTRACT

Decorative stemware products comprise a base having upper and lower primary surfaces with the lower primary surface defining an interior generally concave cavity and a decalcomania decoration with an image applied to the lower primary surface so that the decoration conformably covers at least a major portion of the lower primary surface of the base and the image is visible from the upper primary surface.

### FIELD OF THE INVENTION

The present invention relates to stemware with decorated bases.

### BACKGROUND OF THE INVENTION

In the past, glass objects, such as plates, have been decorated with decalcomania pictures and/or decals applied to a flat surface as described in U.S. Pat. No. 3,984,273. Wine glasses and other stemware may be configured with a base that has an inner concave contoured cavity which may inhibit successful mass production decoration of this surface of the base. At least one manufacturer has filled in the concave space of the base of wine glasses with a filler material such as epoxy and then applied a flat paper label to provide a decorative base that is viewable from the top surface.

### SUMMARY OF THE INVENTION

Embodiments of the present invention provide stemware with decorative bases whereby the decoration substantially conforms to the generally concave or contoured shape of the base cavity. In particular embodiments, the stemware may be glass stemware with an integral stem that merges with the base. The glass stemware may be a wine glass, champagne glass, beer glass, martini glass, margarita glass or pedestal serving container. The methods to apply the decoration may provide more economic and/or improved mass production decorative capability.

Certain embodiments are directed to serving, eating and/or drinking stemware products. The products include a base connected to a lower portion of an upwardly extending stem. The base has upper and lower primary surfaces with the lower primary surface defining a generally open concave cavity. The products also include a decalcomania decoration with an image on an upper side thereof. The upper side of the decalcomania decoration being applied to the lower primary surface of the base so that the decoration conformably covers a major portion of the lower primary of the base with the decalcomania image visible from the upper primary surface of the base. The decalcomania image can be panoramic to provide an unlimited view of all visible objects over a wide area (typically 360 degrees) of the base via the top surface of the base.

In particular embodiments, the base cavity includes an upwardly oriented well center portion that is axially aligned with the stem and the decalcomania continuously conformably extends over the surface of the cavity wall including the recessed center portion. The well may be generally arcuate.

In some embodiments, the base cavity includes an outer perimeter lip that terminates into an intermediate portion that extends vertically above the lip and inwardly therefrom to terminate into the well and the decalcomania decoration conformably occupies substantially the entire lower primary surface of the base (including the well) inside the lip.

In addition, the decalcomania decoration can include color that, when applied, projects visually upwardly from the cavity to visually appear in the lower portion of the stem.

Other embodiments are directed to methods of fabricating stemware products with a decorated base. The methods include: (a) providing a stemware product comprising a stem connected to a base, the base having opposing upper and lower primary surfaces, the lower primary surface defining a generally concave cavity; (b) applying a decal with an image thereon to the lower primary surface of the base so that the decal substantially conforms to the shape of the base cavity; and (c) heat-sealing the decal to the lower primary surface of the base so that the decalcomania image is viewable from the upper surface of the base.

The method can also include repeating the steps a plurality of times to provide a matching set of stemware with the same decal image thereon. The decals can be customized with drawings, pictures, words and the like, typically corresponding to customizable different users/applications.

The foregoing and other objects and aspects of the present invention are explained in detail herein.

### BRIEF DESCRIPTION OF THE DRAWINGS

FIG. 1 is a flow chart of operations that may be carried out according to embodiments of the present invention.

FIG. 2A is an exploded view of a stemware article with an associated substantially flat conformable decal targeted for application onto the base cavity surface according to embodiments of the present invention.

FIG. 2B is a cross-sectional view of the stemware article and decal shown in FIG. 2A.

FIG. 2C is a cross-sectional view of the stemware article and decal shown in FIGS. 2A and 2B with the decal conformably applied to the contoured base cavity according to embodiments of the present invention.

FIG. 2D is a bottom perspective view of an exemplary wine glass with a decorated base according to embodiments of the present invention.

FIG. 2E is a partial cross-sectional view of an alternate base cavity configuration according to other embodiments of the present invention.

FIG. 2F is a partial cross-sectional view of yet another alternate base cavity configuration according to embodiments of the present invention.

FIG. 3 is a digital picture of an exemplary base-decorated wine glass according to embodiments of the invention, shown adjacent non-decorated wine glasses.

FIG. 4 is a digital picture of an exemplary margarita base-decorated glass according to embodiments of the present invention.

FIGS. 5A and 5B are front views of exemplary champagne glasses according to embodiments of the present invention.

FIG. 6 is a front view of a pedestal serving dish according to embodiments of the present invention.

FIG. 7A is a top view of an example of a decalcomania decal according to embodiments of the present invention.

FIG. 7B is a side view of the decal shown in FIG. 7A.

FIG. 8A is a top view of another example of a decalcomania decal according to embodiments of the present invention.

FIG. 8B is a side view of the decal shown in FIG. 8A.

### DETAILED DESCRIPTION OF EMBODIMENTS OF THE INVENTION

The present invention will now be described more fully hereinafter with reference to the accompanying figures, in which preferred embodiments of the invention are shown. This invention may, however, be embodied in many different forms and should not be construed as limited to the embodiments set forth herein. Like numbers refer to like elements throughout. In the drawings, layers, regions, or components may be exaggerated for clarity. In the figures, broken lines indicate optional features unless described otherwise. The method steps are not limited to the order in which they are set forth.

The present invention is directed to stemware with decorated bases. The base comprises a substrate material that is translucent and/or transparent so that a decalcomania picture applied to an underside of a base of the stemware can be seen from the top surface of the base. The stemware can be formed from any suitable material including polymer and/or copolymer materials and blends and derivatives thereof. Typically, the polymer/copolymer materials will be configured as multiple use stemware or higher end stemware (as opposed to conventional single-use plastic ware) such as styrene stemware. However, particular embodiments of the present invention are directed to glass stemware. The terms “glass”, “glassware”, “glass stemware” and derivatives thereof, refer to any suitable glass substrate material that is typically frangible and translucent or transparent and also typically comprises silica materials. The glassware may include lead or be substantially lead free.

In certain embodiments, the glass stemware can be coated with a thin outer coating layer for improved impact resistance as described, for example, in U.S. Patent Application Publication No. 20020064616, published May 30, 2002, and U.S. Pat. No. 6,346,315, the contents of which are hereby incorporated by reference as if recited in full herein. Typically, the coating is applied after the decalcomania decoration is applied.

The decalcomania decoration can be applied in an indirect printing process as is known to those of skill in the art. The decalcomania decoration can be preprinted on paper, a thin (typically film) elastomer, or other desired conformable substrate. In certain embodiments, the decalcomania decoration is applied via a heat-release decal that is moistened or wetted to position the decal on the target surface and to take the desired conformal shape and that is configured with the transferable decalcomania art, picture, image and/or text. However, in other embodiments, the decalcomania decoration may be configured as a dry and/or cold decal with transferable picture and/or applied via other image transfer processes including sublimation or direct printing processes. See U.S. Pat. Nos. 3,984,273; 4,399,178; 4,280,939; 4,451,307; 5,308,426; 5,397,410; 5,962,368 and 6,149,747: the contents of these documents are hereby incorporated by reference as if recited in full herein.

The decalcomania decal can be a multi-color heat-release decal that, when transferred to the base, integrally conformably attaches (i.e., fuses to the substrate) to the target contoured base cavity surface. In certain embodiments, the decalcomania decoration has a predominant color that visually projects upwardly through a lower portion of an integrally attached stem.

In certain embodiments, the decorated-base stemware is configured to be dishwasher safe, with the decalcomania decoration remaining visually intact on the stemware, for at least a predetermined number of wash cycles, as defined by (U.S. Federal) and/or other applicable regulatory standards.

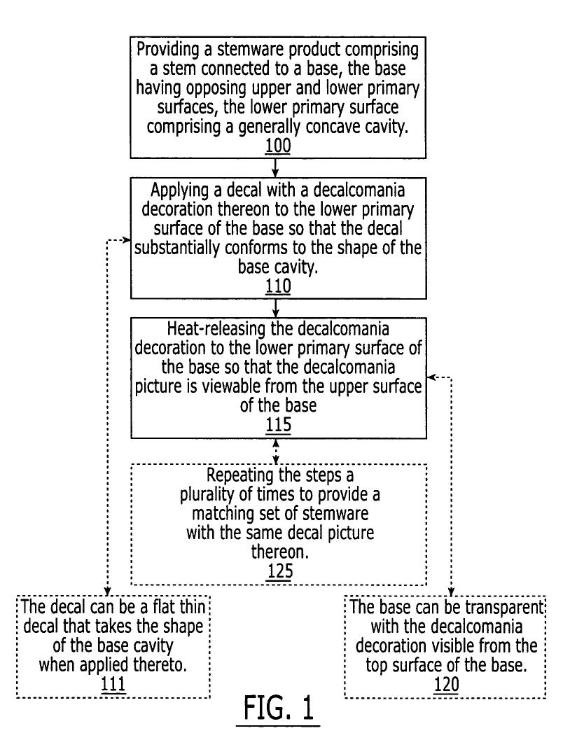

Turning now to FIG. 1, exemplary operations that can be used to fabricate a decorated stemware base are shown. A stemware product comprising a stem connected to a base is provided. The base has opposing upper and lower primary surfaces. The lower primary surface comprises a contoured generally concave cavity (block 100). The concave cavity can be a relatively flat concave contour or a relatively steep contour. The cavity is typically configured with a generally open underside, with the contiguous wall of the base cavity configured to taper down to define a relatively small outer perimeter contact surface for supporting the stemware when seated on a counter, table or serving tray.

The generally concave cavity can include a central peak or upwardly projecting well or recess portion that rises above the other portion of the cavity. However, in other embodiments, the central upper portion of the cavity may include a stem depression region. In any event, a decal with a decalcomania decoration is applied to the underside of the base onto the lower primary surface so that the decal substantially conforms to the shape of the base cavity (block 110). The decal can be configured so that it substantially seamlessly extends over at least a major portion of the surface of the base cavity so that the image thereon covers at least a major portion of the lower base primary surface. Typically, the decal conformably extends into the upwardly projecting recess and laterally and downwardly away therefrom. After applying the decal to the target surface, the decalcomania decoration can be heat-released and/or sealed to the base cavity to form a thin continuous outer layer with the decoration firmly attached to the lower primary surface so that it is visible through the base from the upper primary surface (block 115). The heating can be carried out with the decal held in place by its own action without requiring vacuum or pressure applied during heating to effectuate the transfer of the decalcomania decoration to the target contoured surface. The heating temperature will be dependent upon the substrate and content of the decalcomania/decal as is well known to those of skill in the art, but the temperature should be below the glass or base substrate melting temperature.

In certain embodiments, the base of the stemware is transparent, with the decalcomania decoration conformably secured against the surface of the base cavity but being visible from the top surface of the base after heat-release (block 120). The decal can be a thin flat decal (pre-application) that takes the shape of the base cavity when applied thereto (block 111). The operations can be repeated to provide a matching set of stemware with substantially the same image/decoration thereon (block 125). The process may be performed in a mass-production environment (typically over a hundred items per shift per operator, and more typically over five hundred per shift per operator) to provide the desired decorated commodity.

In certain embodiments, the decal can be moistened and manually applied to the base cavity. The decal can be rubbed or pressed in a manner that removes air bubbles or excess moisture that may inhibit the seamless and/or successful release of the decoration onto the contoured substrate. The moistened or wetted decal releaseably attaches to the contoured substrate and is configured to sufficiently adhere so as to remain substantially in place, in a desired alignment against the inner surface of the contoured cavity, as pressure is applied from the center outward to work the bubbles and/or excessive or undue moisture out from between the target inner surface and decal layer. The stemware is then heated (at least locally proximate the base) which releases and integrates the decalcomania decoration onto the bottom base surface.

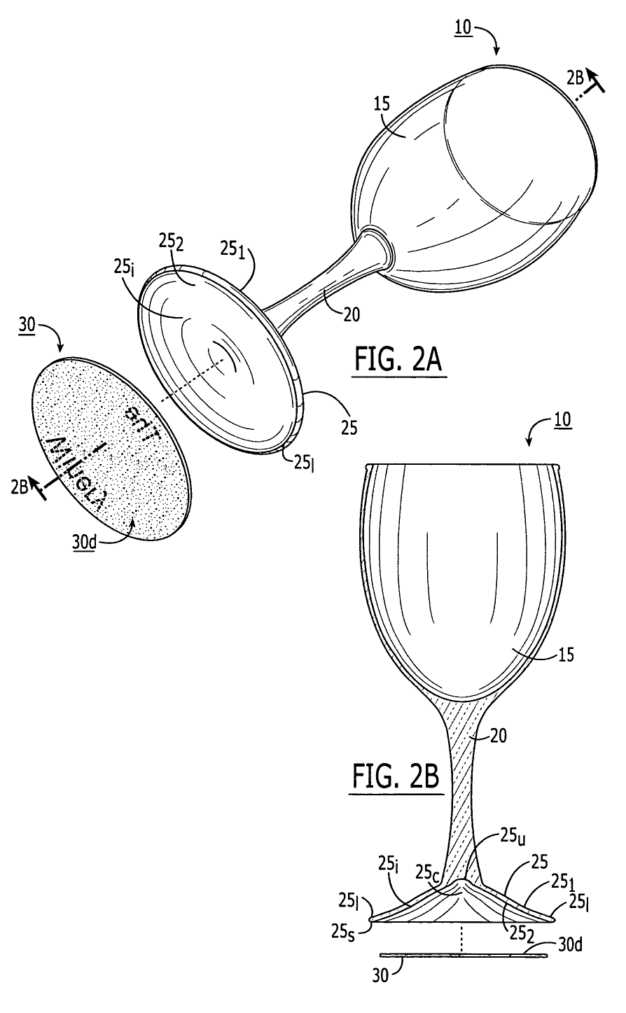

FIG. 2A illustrates an exploded view of a stemware product 10 having a container 15 with a stem 20 that terminates into a base 25 and a decalcomania decoration 30d (represented by the shading and/or cross-hatch marking) held on a decal 30 and positioned proximate thereto. FIG. 2B illustrates an exemplary cross-sectional view taken along line 2B-2B shown in FIG. 2A. The base 25 has opposing upper and lower primary surfaces, 25₁, 25₂ respectively, the lower surface 25₂, defining an enclosed cavity 25c. As described above, the generally concave cavity 25c can have a relatively flat concave contour, a relatively steep contour, and/or combinations of the same. The cavity 25c is typically configured with a generally open underside, with the contiguous wall of the base cavity configured to taper down to define a relatively small outer perimeter flat or planar contact surface 25s for supporting the stemware 10 when it is seated on a counter, table or serving tray.

The cavity 25c can be shaped with a substantially centrally located well 25u that extends upwardly that is substantially axially aligned with the stem 20. In certain embodiments, the wall of the base cavity 25c may be contoured so that the uppermost well 25u has a smaller surface area with a greater radius of curvature than an intermediate portion 25i. For example, FIG. 2B illustrates that the intermediate portion 25i may be substantially straight with a generally constant slope from the lower bounds of the well 25u to the lip 25l, while FIG. 2E illustrates that the intermediate portion 25i may have a slight curvilinear configuration as it travels from the upper portion 25u to the lip 25l. As such, the intermediate portion 25i may reside above a support surface that typically is configured as an outer perimeter lip 25l. In other embodiments, such as shown in FIG. 2F, the center portion of the base cavity 25c which resides axially aligned with and under the stem 20 may be configured as a downwardly projecting portion (FIG. 2F, 25d) and the intermediate portion 25i of the base wall may extend above and below the depressed portion 25d to define the generally concave interior cavity 25c.

The well 25u may be configured as a curvilinear, generally arcuate or frustoconical peak with sides that travel outwardly and downwardly therefrom with a relatively steep slope while the intermediate portion 25i may travel downwardly and outwardly away from the upwardly projecting portion 25u with a more gradual slope. As shown in FIGS. 2B, 2C and 2E, the upwardly oriented well 25u can be a single centrally located projecting peak (typically not sharply pointed) or the center can include a downwardly oriented projection (25d, FIG. 2E, also typically blunt or rounded rather than configured with a sharp edge) which travels substantially symmetrically circumferentially downward and outward (360 degrees) and the decal 30 and/or decalcomania decoration 30d can conform to these shapes and cover a major portion of the inner surface of the base cavity 25c, and more typically can cover substantially the entire inner surface of the cavity 25c. As noted above, the stem 20 can be integrally attached to the base 25 and may be solid.

The decalcomania decal 30 can be configured to cover substantially the entire surface area of the base cavity 25c. In proper position, the decalcomania decoration 30d can provide a substantially continuous seamless conformal covering with the image secured against the lower primary surface of the base and viewable from the upper primary surface of the base. As shown in FIG. 2C, the decal 30 (and the decalcomania decoration 30d) takes on the shape of the cavity 25c so that the decal and/or decoration conformably resides against the surface of the well 25u. Typically, the decal 30 covers at least a major portion of the interior surface of the base cavity 25c, and more typically substantially the entire surface of the cavity 25c. The decoration 30d may reside about a selected portion or over substantially all of the decal 30. As shown in FIG. 2A, the decalcomania decal 30 can have a planar substantially circular thin body. The term thin means that the decal when applied does not add substantially thickness to the substrate. Typically, the thin decal body is configured as a film, having a thickness of less than 1 mm, and more typically less than about 0.05 mm. In any event, after successful transfer of the decoration 30d, the decalcomania decoration 30d can reside directly on (fuses on and/or into) the substrate of the lower primary surface in the base cavity 25c of the stemware 10. The decal 30 can have a width that is less than the width of the base 25 so as to reside inside the lip 25l of stemware 10 having a lip 25l. In other embodiments, the decal 30 can be sized to be substantially coextensive with the surface area of the surface of the base cavity 25c, typically undersized so as to not extend above or over the outer edges of the bottom of the base 25.

Thus, in certain embodiments, when applying the preformed decal 30, the decal sheet bends or folds to conform to the base cavity 25c and the decoration 30d may be configured as a substantially continuous surface or layer over the base cavity 25c so that image is transferred unblemished or unmarred by the application process. The underside of the decoration layer 30d may have a tactile gritty feel (which is in contrast to the typically smooth surface of the remainder of the base). The sheet 30 can be moistened or wetted after it is in the base cavity 25c and/or before (and/or the surface of the base cavity can be moistened or wetted before the decal is placed thereon). The decal 30 can be massaged or gradually manipulated to remove any unwanted air bubbles and undue moisture that may be trapped between the decal 30 and the transfer surface 25₂ (typically starting from the center and working out toward the edges) to provide a seamless conformal decoration. When the decorative transfer is complete, and when viewed from the bottom, the decalcomania decoration 30d can provide a thin continuous seamless layer over the target surface portion of the base cavity 25c with a visually correct (non marred or blurred) image projecting through the top surface of the base 25.

In certain embodiments, the bottom (exposed) surface of the applied decoration can have a first color that is less vibrant and/or different than the top surface of the decoration that is viewable from the top surface of the base 25. For example, the bottom of the decoration layer can be white or off-white, while the top integrated image of the decoration may have multiple colors. In other embodiments, the bottom of the decoration layer will be more muted or less intense than that of the top. It is noted that as used herein black is considered a color. The decalcomania decal can be a ceramic decal, and more typically is a glass heat-release decal. Suitable decalcomania decals can be obtained from Heinrich Ceramic Decal, Inc., located in Worcester, Mass. 01603.

The decoration 30d can comprise a single or multi-colored picture or image, a primary background color with contrasting or complementing alphanumeric characters (i.e., text). For example, the decoration 30d when viewed from the top can portray licensed or original art, designs that match and/or complement flatware or serving ware, or other decorations, such as dishware, china and the like. Because the application process can be relatively economical, the decoration 30d can be customized art or messages, logos, trademarks, company names (such as vineyard names, brewery names, wine shop, pubs and restaurant names, school or sports team names/logos) and the like, wedding dates and bride/groom names, reunions, celebrations, special events, pictures or images, private or public group names and symbols, images, designs and other suitable customized features.

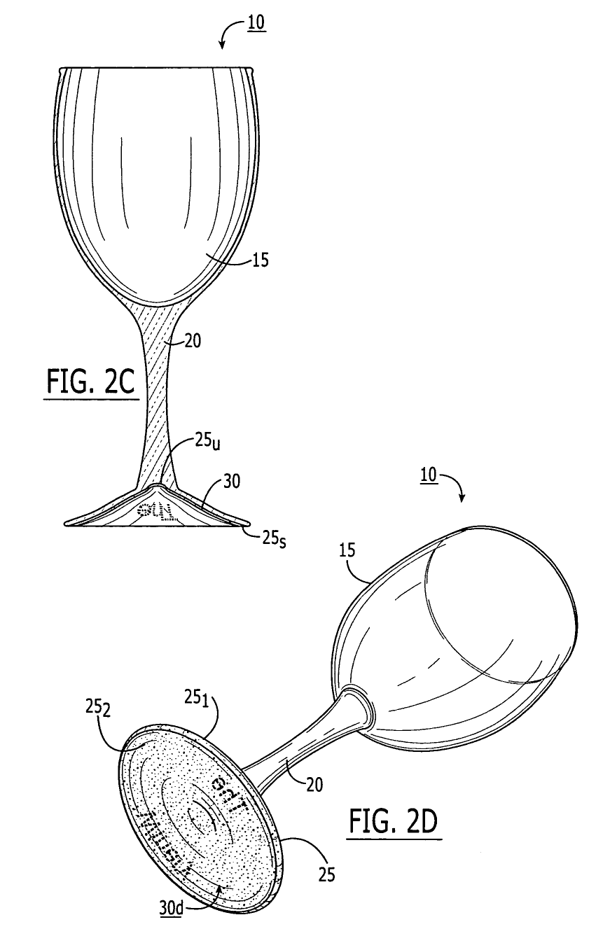

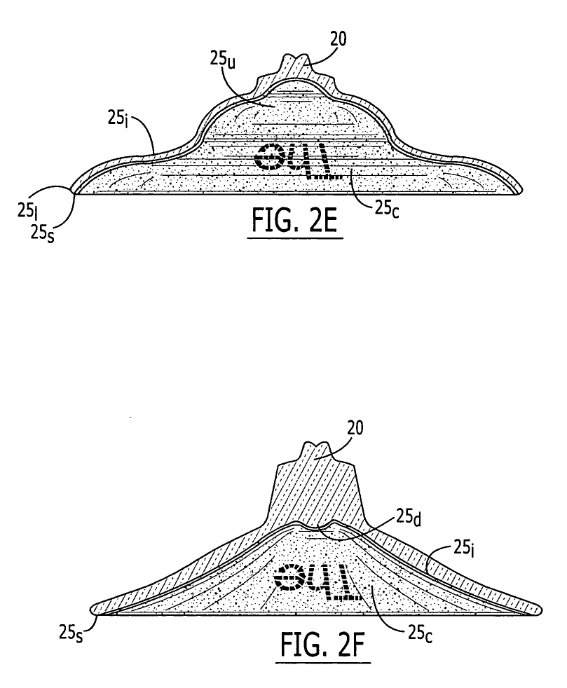

As shown in FIG. 3, in particular embodiments, the decoration 30d is configured with a visually prominent color that, while physically stopping in the underside of the base and in the well 25u of the base cavity 25c, visually projects a distance above the base 25 upwardly through a lower portion of the stem 20l. Thus, while the stem 20 can be clear and/or transparent (as is the base substrate as shown in FIG. 3), the lower portion of the stem 20l appears translucent with color, image and/or design corresponding to that provided by the decalcomania decoration 30d on the wall of the base cavity 25c. The remainder of the wine glasses shown in FIG. 3 are conventional and without the decalcomania decoration 30d. FIG. 4 illustrates an exemplary decorated margarita glass 10. In this embodiment, the decoration 30d complements a decoration on serving ware (shown as an adjacent plate). Suitable glassware (wine margarita, and champagne glasses) is available from ARC International North America located in Millville, N.J. Suitable stemware may also be obtained from other manufacturers known to those of skill in the art.

In addition, application and firing of the decal to the stemware can be carried out by techniques performed by one or more of the following: Baltimore Glass and Ceramic Decorators, located in Baltimore, Md.; Chattanooga Labeling Systems, located in Chattanooga, Tenn.; and Catamount Glass, located in Bennington, Vt.

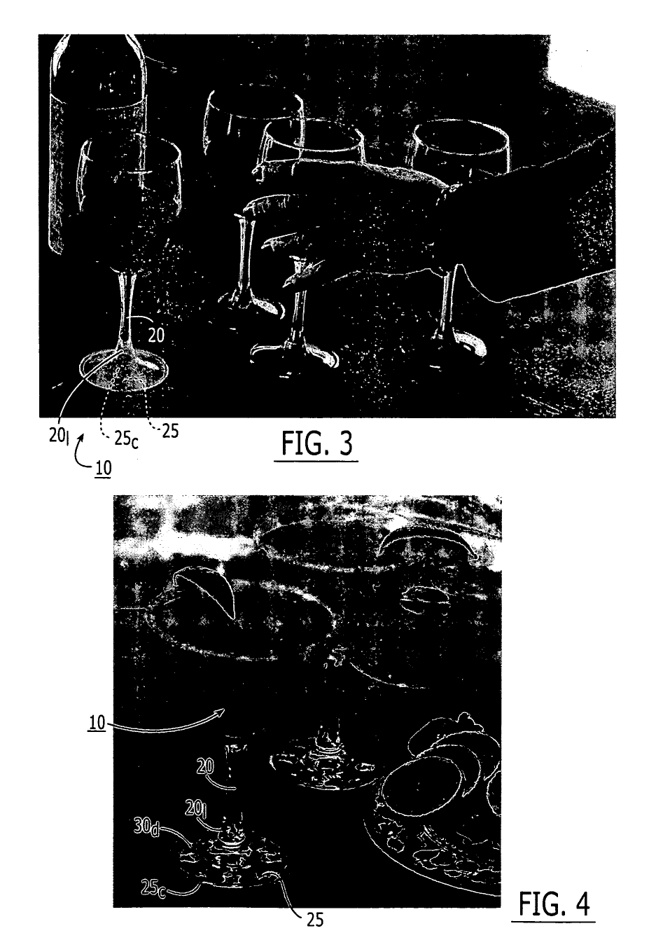

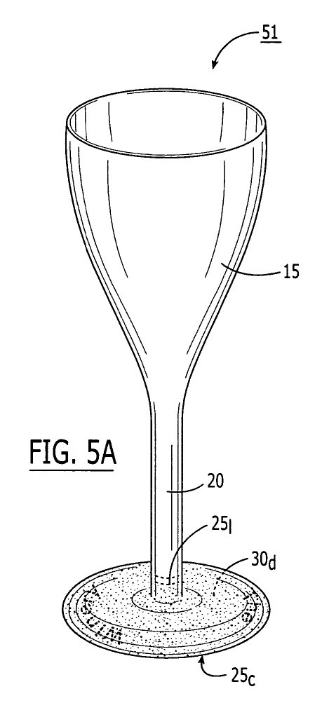

The base-decalcomania decorations provided by the instant invention for stemware may be suitable for other stemware (in addition to the wine glasses and margarita glasses discussed above) such as, but not limited to, champagne glasses 51 (FIG. 5A) and/or 51′ (FIG. 5B), beer glasses 52 (FIG. 5C), and glass pedestal serving ware and/or bowls, shown for example at 50 in FIG. 6, as well as other stemware items such as martini glasses (not shown). The pedestal serving ware 50 is shown as a bowl in FIG. 6, but may configured as a plate such as a cake plate, or other pedestal supported container. In certain embodiments, particularly with respect to the pedestal serving ware 50, the base 25 may be elongate rather than circular, but also includes a cavity 25c to which the decoration 30d is applied as discussed for the above-described embodiments. In each of the embodiments illustrated, the decoration 30d is illustrated by the shading/cross-hatch markings.

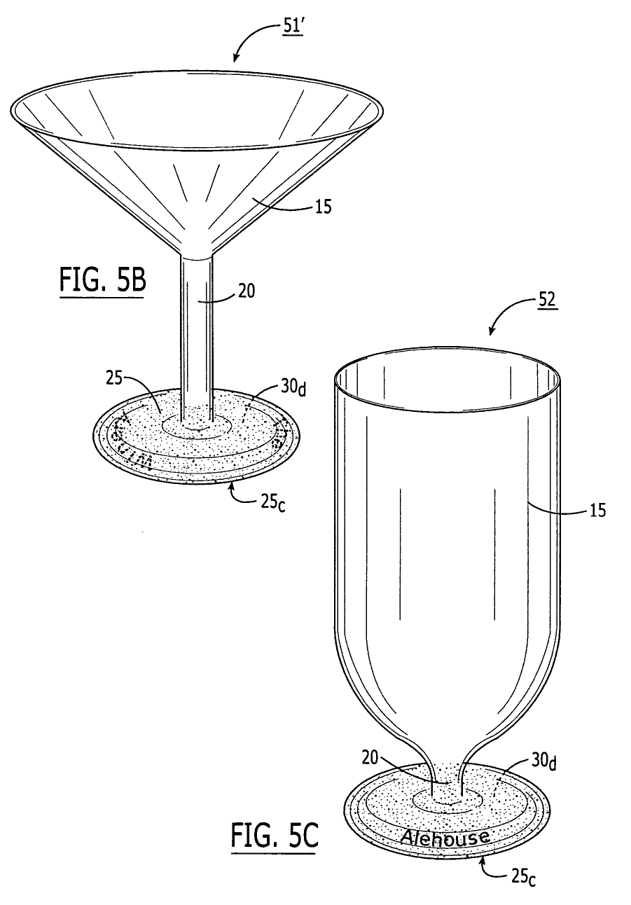

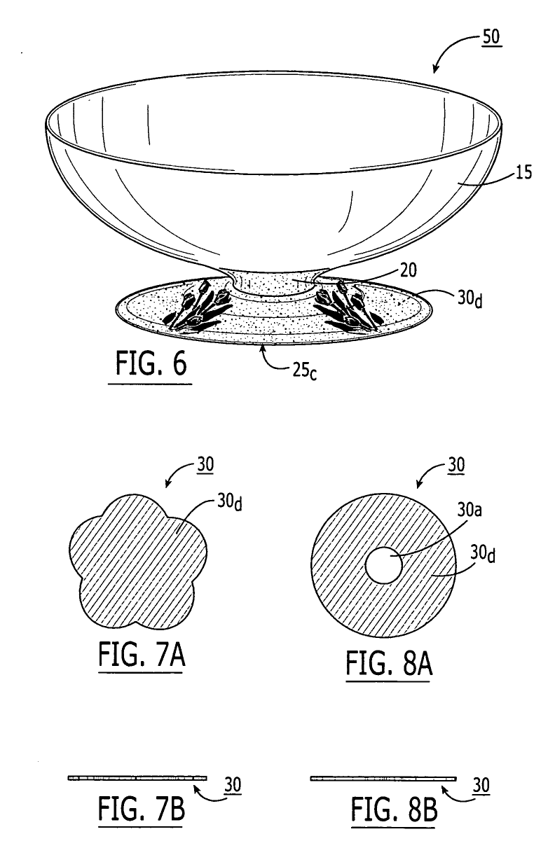

FIG. 7A illustrates an alternate embodiment of a decalcomania decal with an irregular perimeter. Other desired shapes can also be used. FIG. 8A illustrates that the decal 30 may be configured with a center aperture 30a. FIGS. 7B and 8B illustrate that the decal 30 is thin and conformable. In any event, the decalcomania decal 30 is typically configured as a continuous sheet, which can have a panoramic image or picture thereon (i.e., the image (color(s) and/or artwork) is provided over a wide area, typically about 360 degrees). In certain embodiments, the decal sheet can be sized to substantially correspond to the size of the cavity. For example, the surface area can be substantially the same as that of the surface area of the base cavity wall.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A serving, eating and/or drinking stemware product, comprising:
a base connected to a lower portion of an upwardly extending stem, the base having upper and lower primary surfaces with the lower primary surface defining a generally open concave cavity; and
a decalcomania decoration with an image on an upper side thereof, the upper side of the decalcomania decoration being applied to the lower primary surface so that the decoration conformably covers a major portion of the lower primary of the base with the decalcomania image visible from the upper primary surface of the base.

2. A stemware product according to claim 1, wherein the base is transparent.

3. A stemware product according to claim 1, wherein the base is translucent.

4. A stemware product according to claim 1, wherein the stemware is formed of glass.

5. A stemware product according to claim 4, wherein the stem comprises opposing upper and lower portions, the product further comprising an upper container vessel connected to the stem upper portion.

6. A stemware product according to claim 5, wherein the stemware with the decalcomania decoration is dishwasher safe.

7. A stemware product according to claim 4, wherein the glass stemware has an integral glass stem, base and container.

8. A stemware product according to claim 7, wherein the decalcomania decoration is a color heat-release decal image.

9. A stemware product according to claim 1, wherein the lower primary surface of the base includes an outer perimeter lip, and wherein the decalcomania decoration seamlessly conformably covers substantially the entire lower primary surface of the base inside of the lip.

10. A stemware product according to claim 1, wherein the base cavity includes an upwardly oriented recessed center portion that is axially aligned with the stem, and wherein the decalcomania image continuously extends over at least a major portion of the lower primary surface of the base including the recessed center portion.

11. A stemware product according to claim 1, wherein the base cavity includes an outer perimeter lip that terminates into an intermediate portion that extends vertically above the lip and inwardly therefrom to merge with a center portion, and wherein the decalcomania decoration covers the center portion and substantially the entire lower primary surface of the base cavity inside the lip.

12. A stemware product according to claim 1, wherein the decalcomania decoration image comprises color, and wherein the color is visually projected upwardly from the lower primary surface to visually appear in the lower portion of the stem.

13. A stemware product according to claim 7, wherein the product is a wine glass.

14. A stemware product according to claim 7, wherein the product is a margarita glass.

15. A stemware product according to claim 7, wherein the product is a champagne glass.

16. A stemware product according to claim 1, wherein the product is glass, and wherein the decalcomania decoration image is fused onto the glass substrate of the lower primary surface of the base cavity.

17. A method of fabricating a stemware product with a decorated base suitable for providing food and/or drink, comprising:
providing a stemware product comprising a stem connected to a base, the base having opposing upper and lower primary surfaces, the lower primary surface defining a generally concave cavity;
applying a decal with an image thereon to the lower primary surface of the base so that the decal substantially conforms to the shape of the base cavity and so that the image resides against and conforms to the lower primary surface; and
heat-sealing the decal to the lower primary surface of the base so that the decalcomania image is viewable from the upper surface of the base.

18. A method according to claim 17, further comprising repeating the providing, applying and heat-sealing steps a plurality of times to provide a matching set of stemware with the same decal image thereon.

19. A method according to claim 17, wherein the base is transparent.

20. A method according to claim 17, wherein the base is translucent.

21. A method according to claim 17, wherein the stemware is formed of glass.

22. A method according to claim 21, wherein the stemware is dishwasher safe.

23. A method according to claim 21, wherein the glass stemware has an integral glass stem, base and upper container.

24. A method according to claim 17, wherein the lower primary surface of the base includes an outer perimeter lip, and wherein the decalcomania decoration defines a decorative thin layer that seamlessly conformably covers substantially the entire lower primary surface of the base inside of the lip.

25. A method according to claim 17, wherein the base cavity includes an upwardly oriented recessed center portion that is axially aligned with the stem, and wherein the decalcomania image continuously extends over at least a major portion of the lower primary surface of the base cavity including the recessed center portion.

26. A method according to claim 17, wherein the stemware base cavity includes an outer perimeter lip that terminates into an intermediate portion that extends vertically above the lip and inwardly therefrom to terminate into a center portion, and wherein the decalcomania decoration seamlessly occupies substantially the entire lower primary surface inside the lip to provide an unmarred image.

27. A method according to claim 17, wherein the decalcomania image comprises color, and wherein the color is projected upwardly from the lower surface of the base proximate the stem to visually appear to reside in a lower portion of the stem.

28. A method according to claim 23, wherein the product is a wine glass.

29. A method according to claim 23, wherein the product is a margarita glass.

30. A method according to claim 23, wherein the product is a champagne glass.

31. A method according to claim 23, wherein the product is glass, and wherein the decalcomania image is fused into the glass substrate of the lower primary surface of the base responsive to said heat-sealing step.
